(19) United States
(12) Patent Application Publication
(10) Pub. No.: US 2006/0129325 A1
(43) Pub. Date: Jun. 15, 2006

(54) Integration of microarray data analysis applications for drug target identification

(76) Inventors: Tina (Hong) Gao, Lexington, KY (US); Jane Huffman Hayes, Clay City, KY (US); Henry Hui Cai, Columbus, OH (US)

Correspondence Address: MCDERMOTT,WILL & EMERY, 600 13th Street, N.W., Washington, DC, 20005-3096, US

(21) Appl. No.: 11/008,565

(22) Filed: Dec. 10, 2004

(51) Int. Cl. G06F 19/00; G06Q 10/00; G06Q 50/00

(52) U.S. Cl. 702/19; 705/2

(57) ABSTRACT

An analyzing system for analyzing microarray experiment data showing the arrangement of a gene to identify targets in drug discovery. Remotely located service providers are each configured for analyzing the microarray experiment data in a predetermined sequential manner. Analysis information including at least what type of analysis each service provider can perform is stored in the system. At least one of the service providers which performs a desired analysis on the microarray experiment data is selected based on the analysis information. Then, the selected service provider is requested to analyze the microarray experiment data for identifying targets in drug discovery.

### TECHNICAL FIELD

Embodiments described below relate generally to a system and method for integrating microarray data analysis applications for drug target identification. Specifically, the embodiments relate to a system and method for analyzing microarray experiment data for genes.

### BACKGROUND OF THE INVENTION

The recent success in the Human Genome Project and other projects of sequencing genomes of many model species, such as human, yeast, mouse, fruitfly, etc. has brought new hopes in drug discovery. The better understanding of human genes can facilitate scientists to identify more targets and design more effective drugs. Accordingly, pharmacogenomics has attracted tremendous interests among biologists and pharmacologists. However, traditional techniques based on “one gene in one experiment” are slow in making out the functions of all genes of human genome. Genomics methodologies, like microarrays, have been recently implemented to augment the progression of genetic analysis.

Thousands of genes and their products (i.e., RNA and proteins) in a given living organism function in a complicated and intertwined way that creates the mystery of life. According to a microarray technology, the arrangement of a large scale of those gene products in a microarray makes it possible to monitor the whole genome on a single chip. Thus, researchers can have a better picture of the interactions among thousands of genes simultaneously. Current clustering algorithms can group together genes showing the similar expression patterns on microarray experiments. This grouping indicates the possible close relationships among the clustered genes under a special condition. If the relationship can be proved by experiments, the proteins that regulate all these genes at the same time are often the subjects of further research because they may be the first switch to be turned on with a change of the environment. The genes from which these proteins are produced could be the best targets for drug development.

Since a microarray experiment can make use of common analysis systems and not take a very long time to perform, large numbers of experimental data can be collected within a short period of time. However, the task of processing this large amount of data is difficult. Also, a standard data format does not exist for analyzing microarray experiment data and many applications cannot work with data in a different data format. The subject matter described herein addresses that shortcoming.

### SUMMARY OF THE DISCLOSURE

Embodiments detailed herein describe a system and method for analyzing microarray experiment data to identify targets in drug discovery. The embodiments may use web services for integrating data and applications in a microarray data analysis. The embodiments allow not only seamless integration between heterogeneous applications but also instant browsing capability of different web services that implement same function interface. The embodiments also allow users to create an analysis procedure.

In one aspect of the disclosure, an analyzing system comprises service providers each configured for analyzing the microarray experiment data in a predetermined manner. A registry is included in the system, which is configured for storing analysis information including at least which analyses each service provider can perform. A service requestor is configured for selecting at least one of the service providers which performs a desired analysis on the microarray experiment data based on the analysis information in the registry. The requester then requests the selected service provider to analyze the microarray experiment data, and receives an analysis result from the at least one of the service providers.

In one embodiment, the service providers, registry and service requestor are connected to each other through a network.

The system may include at least a first service provider configured for performing a first analysis to identify a gene expression pattern from the microarray experiment data; a second service provider configured for performing a second analysis to retrieve sequences of genes with similar expression patterns to that identified by the first service provider; and a third service provider configured for performing a third analysis to cluster the sequences retrieved by the second service provider to locate similar fragments. The analysis information stored in the registry may include information regarding the first, second and third analyses. The service requestor locates the analysis information regarding the first, second and third analyses and selects the first, second and third service providers and requests them to analyze the microarray experiment data.

The analysis information may further include information regarding request formats to be accepted by the respective first to third service providers. The service requestor requests the first to third service providers based on the request formats included in the analysis information.

The service provider, registry and service requester may be configured for communicating with each other based on standardized tag-based markup language. For example, the standardized tag-based markup language is extensible markup language (XML).

In another aspect of the disclosure, an analyzing system includes a portal configured for storing service provider information including at least what analysis each service provider can perform. A service requestor may be configured for providing analysis procedure information to perform necessary analyses of the microarray experiment data, and communicating with the portal to perform the necessary analyses of the microarray experiment data with service providers to be selected. The portal selects service providers based on the service provider information, each of which can perform an analysis defined in the analysis procedure information.

In one embodiment, the analysis procedure information may include a first analysis for identifying a gene expression pattern from the microarray experiment data; a second analysis for retrieving sequences of genes with similar expression patterns to that identified by the first analysis; and a third analysis for clustering the sequences retrieved by the second analysis to locate similar fragments. The portal may select service providers which performs the respective first to third analyses based on the service provider information.

In yet another aspect of the disclosure, a method for analyzing microarray experiment data includes storing analysis information including at least what type of analysis service providers can perform. At least one of the service providers which performs a desired analysis on the microarray experiment data is selected based on the analysis information. The selected service provider is requested to analyze the microarray experiment data. The microarray experiment data is analyzed by the at least one of the service providers, and an analysis result is obtained from the service provider.

In still yet another aspect of the disclosure, a method for analyzing microarray experiment may include preparing analysis procedure information for performing necessary analyses of the microarray experiment data. Service providers are selected based on the service provider information, each of which can perform an analysis defined in the analysis procedure information. Each of the selected service providers is requested to perform the analysis based on the analysis procedure information.

In another aspect, a computer readable medium bears instructions for analyzing microarray experiment data showing the arrangement of a gene to identify targets in drug discovery. The instructions cause the computer to store analysis information including at least what type of analysis service providers can perform, the service providers are each configured to analyze the microarray experiment data in a predetermined manner, and provide the analysis information based on a request from another computer.

In yet another aspect, a computer readable medium may include instructions which cause a computer to obtain analysis information including at least which analysis service providers can perform. The computer selects at least one of the service providers which performs a desired analysis on the microarray experiment data based on the analysis information. The computer also requests the at least one of the service providers to analyze the microarray experiment data, and receives an analysis result from the at least one of the service providers.

In still yet another aspect, a computer readable medium bears instructions which cause a computer to preparing analysis procedure information for performing necessary analyses of the microarray experiment data, the necessary analyses performed by service providers each configured for analyzing the microarray experiment data in a predetermined manner. The computer obtains analysis information, including at least what analysis service providers can perform, to select service providers, each of which can perform an analysis defined in the analysis procedure information. The computer then requests each of the selected service providers to perform the analysis based on the analysis procedure information and obtains analysis results from the selected service providers.

Additional aspects and advantages of the present disclosure will become readily apparent to those skilled in the art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Examples of the subject matter claimed herein are illustrated in the figures of the accompanying drawings and in which reference numerals refer to similar elements and in which:

FIG. 1 illustrates an exemplary web services architecture according to the principles of the invention.

FIG. 2 illustrates an exemplary conceptual web services stack according to the principles of the invention.

FIG. 3 is block diagram of an analyzing system for microarray experiment data to identify targets in drug discovery.

FIG. 4 is a flow chart illustrating an exemplary process of analyzing microarray experiment data according to the principle of the invention.

FIG. 5 is a block diagram illustrating an exemplary computer system to be used for the analyzing system shown in FIG. 3.

FIG. 6 is a block diagram showing system for analyzing microarray experiment of another embodiment according to the principle of the invention.

### DESCRIPTION OF THE INVENTION

The present disclosure is now described in more detail with reference to the accompanying figures.

The present invention applies web services onto data and application integration in microarray data analysis. Preferably, web services may be performed for each data analysis step in the present invention. The utilization of web services and workflow design on the this analysis procedure allows not only seamless integration between heterogeneous application but also instant browsing capability of different web services that implement the same function interface.

The embodiment may use, for example, web services to realize integration of microarray data analysis applications for drug target identification. Web services have gained increasing acceptance in industry because of its capability of keeping distributed applications loosely coupled through their web programmable interfaces. Web services have been widely accepted as a way for businesses to expose their services over the Internet, to speak same interfacing language, and to use document interchangeable formats for deploying any business-to-business systems. Many standards play important roles in assembling web services strategies. Combined effects of all these standards provide an open abstraction layer over the previously exposed APIs.

Web services are known as an interface that describes a collection of operations that are network-accessible through standardized tag-based markup language messaging, such as eXtensible Markup Language (XML) messaging. A web service is described using Web Services Description Language (WSDL), a standard, formal XML notion. It does not only cover all the information necessary for interacting with described web services, including transport protocols, service name, functions, locations, and message formats, but also encapsulates implementation details under an interface. Simple Object Access Protocol (SOAP) may be used as a Remote Procedure Call (RPC) mechanism to enable a remote client to consume web services regardless of the underlying hardware environment and software platforms. SOAP uses HTTP as the base transport and XML documents for encoding of invocation requests and responses across a network. XML documents, called SOAP messages, are generated according to SOAP specification.

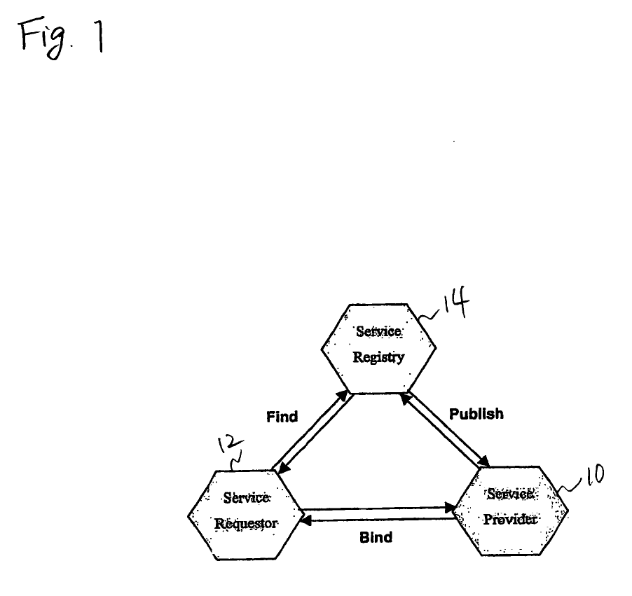

FIG. 1 shows an exemplary web services architecture including a service provider 10, a service requestor 12, and a service registry 14. These three interact with each other through three operations: “publish,” “find,” and “bind,” as shown in FIG. 1.

Service provider 10 is the owner of the service. Service provider 10 makes the service available by publishing services in a service registry in service registry 14. Service requester 12 requests services from service provider 10. Service requester 12 finds an appropriate service provider that provides required services, satisfies the quality of service, and meets other requirements. Service registry 14 provides the descriptions of available services. Service registry 14 stores information for users to obtain general service information, such as service location, service functionality, and provider's information.

As shown in FIG. 1, the description of a web service is published to the specified registry 14 (“Publish”). Thus, service requestor 12 (the user) is able to find and obtain services by simply searching the registry (“Find”) in service registry 14. After finding a suitable service from service registry 14, service requestor 12 sends out a request in a format according to service description (explained below) in order to invoke a web service and then receives a response from service provider 10 (“Bind”).

The service description covers details about a web service, and preferably contains two XML documents, as well as interface and implementation files. The interface file preferably includes four parts: binding, port type, message, and type, for describing protocol, operations, input/output parameters, and use of complex data structures, respectively. The implementation file preferably helps locate a particular service provider, a given service interface, and preferably includes a service element, which consists of a few port elements corresponding to URLs described in binding elements in the interface file. The service description is preferably stored in both service provider 10 and service registry 14.

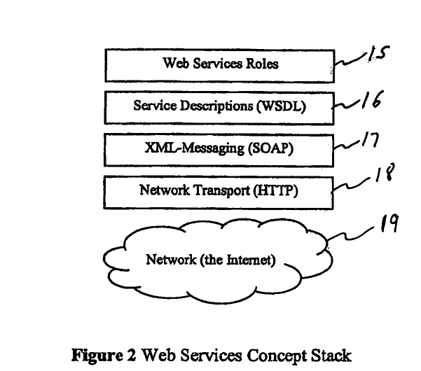

Web services are typically realized with networking. An exemplary conceptual web services stack is illustrated in FIG. 2. As seen in FIG. 2, the foundation for the communication between web services is a network such as the Internet 19. A network transport protocol 18, typically HTTP, is preferably used as the base application protocol for data transportation between the Internet and the service requester 12. In addition to the capability provided by HTTP, a SOAP (Simple Object Access Protocol) 17 is preferably utilized as the XML-messaging layer above the HTTP protocol and encapsulates response and request messages into structured data. Another level, Service Description by WSDL 16, may be utilized above the SOAP to provide another layer of abstraction. Web services roles 15 may be implemented above service descriptions 16.

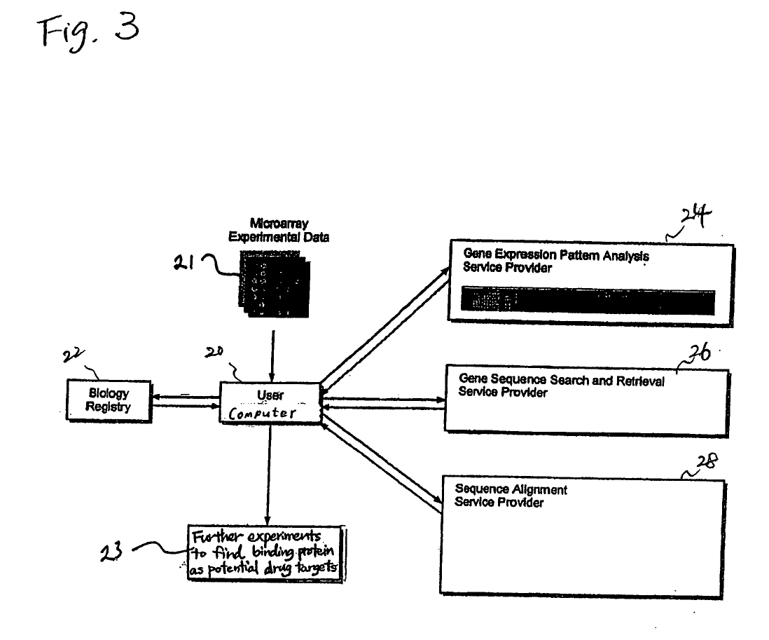

FIG. 3 is an exemplary block diagram showing an exemplary embodiment of an analyzing system and procedure for microarray experiment data to identify targets in drug discovery. The system preferably includes a user computer 20 corresponding to service requestor 12, a biology registry 22 corresponding to service registry 14, and analysis service providers 24, 26 and 28, each of which preferably provides an analysis of the microarray experiment data corresponding to service provider 10.

Analysis service providers 24, 26 and 28 may generally be configured for analyzing microarray experiment data obtained by a user. In more detail, analysis service provider 24 is preferably configured for providing a gene expression pattern analysis, analysis service provider 26 is preferably for gene sequence search and retrieval, and analysis service provider 28 is preferably for sequence alignment. Services provided by the analysis service providers are further explained below.

Biology registry 22 may be configured for storing analysis information including at least which types of analyses each of service providers including analysis service providers 24, 26 and 28, and other service providers can perform. Biology registry 22 may also include URLs for those service providers so that user computer 20 can access a particular provider. The analysis information may further include information regarding request formats to be accepted by analysis service providers 24, 26 and 28.

User computer 20 may be configured for accessing biology registry 22, and selecting at least one of the service providers which performs a desired analysis on microarray experiment data 21 based on the analysis information in the registry. If there are two or more service providers which provide the same analysis, a user can select from all the service providers of the same category returned from the biology registry 22. User computer 21 can obtain microarray experimental data 21 from, for example, its storage and/or databases which may be located on computer 20, a peripheral device or computer associated with computer 20 or in a remote location accessible via the Internet. User computer 20 may then request the selected service provider to analyze the microarray experimental data 21 obtained, and receive an analysis result from the corresponding service provider. User computer 20 requests analysis service providers 24, 26 and 28 for analysis based on the request format information stored in biology registry 22. Further experiments may be performed as illustrated at logical block diagram 23.

A primary interest of the scientists, when studying functional genomics, is how to best analyze coordinated behavior of groups of genes. If a few genes are simultaneously up or down regulated under a variety of experimental conditions, then one may infer a functional relationship among these genes. Thus, identification of gene expression patterns from microarray experiments, which allow for expression levels of thousand of genes to be analyzed in parallel, is critical to understanding a gene function network. Current gene expression analysis schemes mainly follow two strategies, based on either supervised or unsupervised learning algorithms. Hierarchical clustering developed by Michael Eisen is categorized into the unsupervised learning category, while SPLASH by Andrea Califano and SVM the supervised learning methods, which is also known as cell phenotype prediction problem. Selection of algorithm depends strongly on research purposes. For example, SVM outperforms other supervised learning approaches in black box classification.

Researchers retrieve sequences of genes that show a similar expression pattern to understand how they are regulated. Many transcription regulators adjust expression levels of genes by combining to the same specific fragments located in their upstream or downstream areas or even within a genes' coding areas. Quality of match between 3-D structure of the sequence and regulatory protein's structure is indicative of the strength of binding and thus regulatory activity of the gene. Therefore, if a few genes with similar expression patterns are co-regulated by the same protein, then some part of their sequences may be similar, which are possible protein binding sites. Given a gene name or its open reading frame ID (including both the upstream and downstream areas), corresponding sequences can be retrieved from genome databases that store gene sequence information for various organisms.

Studies in the area of multiple sequence alignment aim to find the best commonality of aligned sequences. Algorithms developed often include a scoring scheme that is used to reward agreements among sequences. Once the fragments with high similarities among the identified genes sequences have been found, they can be used as baits to obtain the modification. The data transfer among these applications usually relies on manual efforts. If hundreds of patterns are identified in a set of microarray experiments with at least four genes involved in each pattern. One has to parse those gene names out from the output of a pattern analysis program and retrieve the sequence of each gene one at a time from a genome database. Then she must adjust the formats of all the collected sequences and edit them into a file so that sequence alignment application can take this file as its input.

As shown in FIG. 3, according to the principles of the invention, a user computer 20 obtains microarray experimental data to be analyzed in the system. User computer 20 preferably accesses biology registry 22 to locate URLs of analysis services which provide necessary analysis services. For example, user computer 20 may send a query including a description of an analysis to be performed. Based on such description, biology registry 22 may perform a search of functional descriptions of a plurality of service providers to find service providers which are capable of performing the requested analysis. If two or more service providers providing the same analysis are found by biology registry 22, user computer 20 can select one of them or biology registry 22 may select based on a predetermined standard. Then, user computer 20 sends requests to remotely located analysis service providers 24, 26 and 28, as discussed in greater detail below, thereby obtaining similar fragments from sequences of the genes that have similar expression patterns in the microarray experiment data obtained. The obtained fragments can be used in the further experiments to identify drug targets.

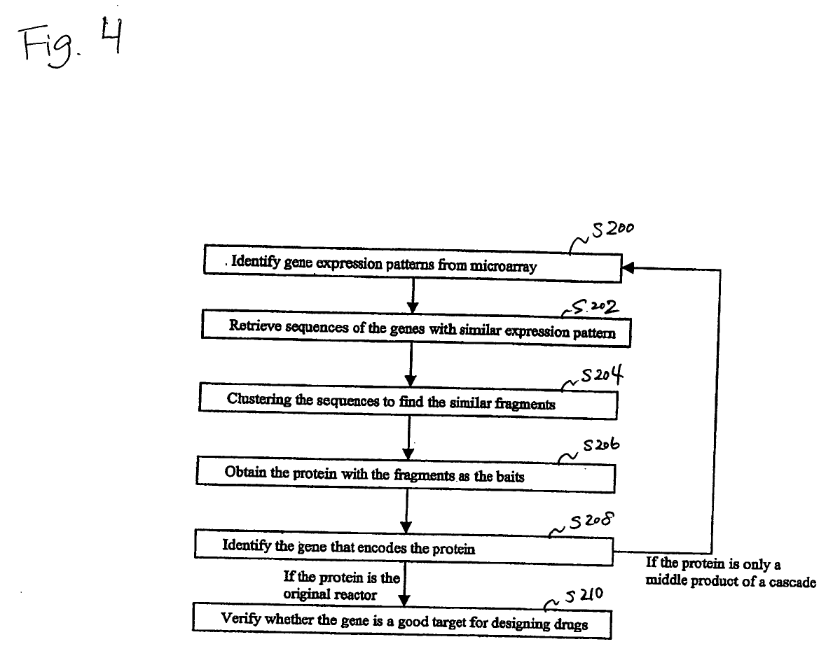

Exemplary analyses performed by analysis service providers including analysis service providers 24, 26, 28 will be explained. FIG. 4 is a flow chart showing exemplary steps of analyzing microarray experiment data. In step S200, microarray data is provided to gene expression pattern analysis 24 via the internet and gene expression patterns are identified from microarray experimental data 21. User computer 20 can obtain from biology registry 22 information showing that analysis service provider 24 is configured for identifying gene expression patterns from microarray experiments. Analysis service provider 24 preferably processes the microarray data to identify common gene expression patterns and provides the identified gene expression patterns to user 20 via the internet in the http protocol. The returned data is preferably wrapped into a Web Service response using the same formats as in the request/query, such as utilizing WSDL, SOAP and HTTP protocols. In this manner, while user computer 20 and gene expression pattern analysis 24 may utilize different computer formats, the use of web services provides layers of abstraction and enables communication between the two and analysis of the microarray data by the service provider of gene expression pattern analysis 24. Moreover, the present invention allows analysis of gene characteristics by utilization of the processing capabilities of different, unrelated entities which may each use different computing formats, e.g. the present invention enables utilization of gene expression pattern analysis service provider 24, gene sequence search and retrieval service provider 26 and sequence alignment service provider 28.

In step S202, user computer 20 packages the genes having the identified expression patterns obtained from analysis service provider 24 into a predetermined format and sends the name or identifier of those genes included in the gene expression pattern data to gene sequence and retrieval service provider 26. User computer 20 may obtains from biology registry 22 information showing that analysis service provider 26 is configured for retrieving sequences of the genes with similar expression patterns. Analysis service provider 26 determines the gene sequences of the genes provided and provides the identified gene sequences to user 20 via the Internet. The returned data is preferably wrapped into a Web Service response using the same formats as in the request/query, such as utilizing WSDL, SOAP and HTTP protocols. In this manner, while user computer 20 and gene sequence service provider 26 may utilize different computer formats, the use of web services provides layers of abstraction and enables communication between the two. Moreover, the present invention allows analysis of gene characteristics by utilization of the processing capabilities of different, unrelated entities which may each use different computing formats, e.g. the present invention enables utilization of gene expression pattern analysis service provider 24, gene sequence search and retrieval service provider 26 and sequence alignment service provider 28.

In step S204, user computer packages the gene sequences provided by service provider 26 into a predetermined format and provides them to a selected sequence and alignment service provider 28. Service provider 28 preferably aligns the sequences and identifies fragments which are similar, e.g., clusters the sequences to find similar fragments. Studies in the area of multiple sequence alignment aim to find the best commonality of aligned sequences. Algorithms developed often include a scoring scheme that is used to reward agreements among sequences. The results of the alignment are provided to user 20 via the Internet. The returned data is preferably wrapped into a Web Service response using the same formats as in the request/query, such as utilizing WSDL, SOAP and HTTP protocols. In this manner, while user computer 20 and sequence alignment service provider 28 may utilize different computer formats, the use of web services provides layers of abstraction and enables communication between the two. Moreover, the present invention allows analysis of gene characteristics by utilization of the processing capabilities of different, unrelated entities which may each use different computing formats, e.g. the present invention enables utilization of gene expression pattern analysis service provider 24, gene sequence search and retrieval service provider 26 and sequence alignment service provider 28.

The following steps S206 to S210 are preferably performed by, for example, other analysis service providers than analysis service providers 24, 26 and 28. In step S206, protein with fragments may be obtained as baits. Once pieces with high similarities among genes have been found, they may be used as baits in the latest molecular biology techniques to obtain proteins that can tightly attach to them.

In step S208, genes that encode the protein are preferably identified. Information of genes that produce proteins can be obtained in many ways, e.g., decoded from protein sequences, retrieved from databases if gene is already available in some databases and directly purified and amplified from an organism in which it is discovered. The genes obtained in this step may be the key to further clarify underlying functional networks. Steps of S200 to S208 can be repeated until original reactors responding to sudden change of environment are found.

When the protein is an original reactor, whether the gene is a good target for designing drugs is verified in step S210.

User computer 20 receives results from each of the analysis service providers. By packaging each application as a service with standard interface, connections among user computer 20, biology registry 22 and analysis service providers 24, 26 and 28 can be independent of the implementation layer.

By using a web service technology, a system that loosely integrates applications that can perform the steps in FIG. 4 can be realized. In one example, the system shown in FIG. 3 is developed by wrapping a web service interface on each selected application and building a platform on which invocation to each service can be initiated. The whole development process will be described below in detail.

Candidate applications that are easy for revision are selected based on the following criteria:

a. They are implemented with good encapsulation of implementation details.

b. They have clear interface definitions.

c. They use simple input and output data structures.

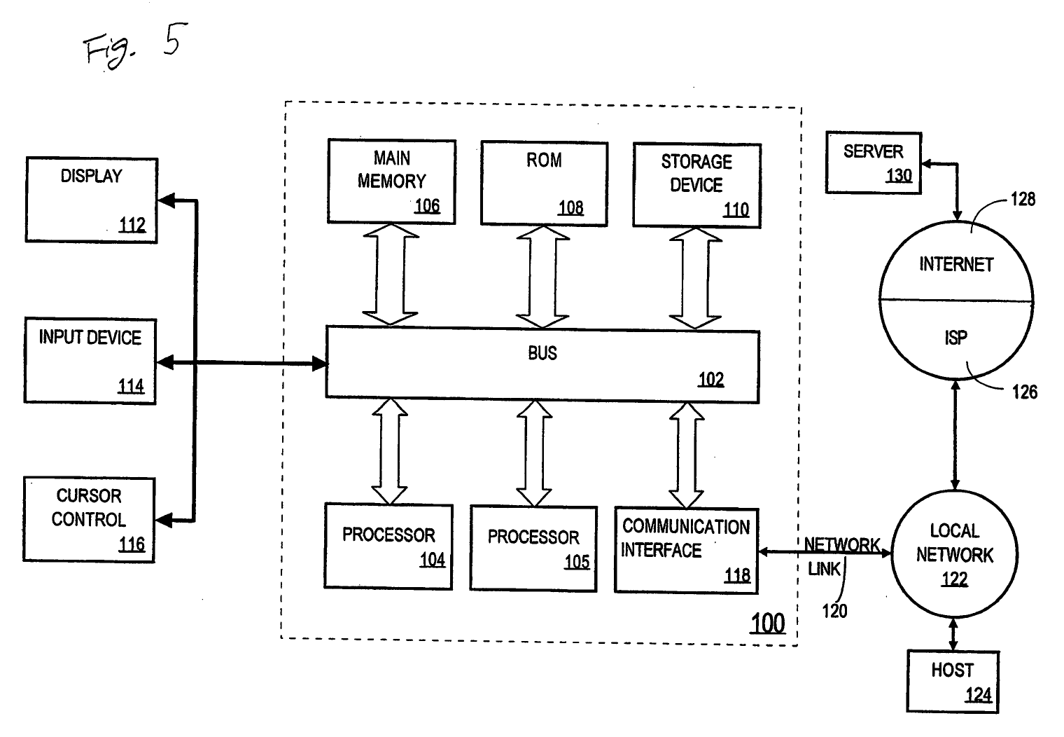

Preferably, applications to be selected preferably are capable of performing the steps shown in FIGS. 3 and 5 for drug discovery research. Three selected applications in this embodiment are listed in Table 1.

TABLE 1
Selected applications for the designed scenario in Drug Discovery

| | Step in | |
|---|---|---|
| Name | | Description |
| IBM's Genes@Work | S200 | A package used to analyze gene |
| | | expression patterns from the |
| | | data obtained by microarray |
| | | technologies. |
| National Center for | S202 | A search and retrieval system |
| Biotechnology Information's | | that stores nucleotide |
| (NCBI) Entrez Databases | | sequences, protein sequences, |
| | | etc. |
| Baylor College of | S204 | A project that provides |
| Medicine's (BCM) Search | | functionality for clustering |
| Launcher | | gene and protein sequences. |

Next, a web service for each step discussed above is built. Many strategies can be used to write a web service. Since the above applications do not provide compatible interfaces that can be easily wrapped into a web service, interfaces of the original component may be modified and migrated to the web services architecture. Then, the interfaces for each application may be rewritten. For Genes@Work, the interface written may take a file with a gene expression dataset and a file with a corresponding phenotype of each microarray experiment as its input, and return an expression pattern file as the output. Since both the input and output files have complicated data formats a SOAP format with attachment technology may be adapted to transfer the files as attachments along with the SOAP messages. Then, a gene accession number may be used in the output file as a query string to the service that obtains access to NCBl's Entrez Databases. The sequence information may be parsed from the XML file returned by a database as an output of this service. The query may be performed through the LocusLink approach provided by NCBI. The service may be composed for step S204 in a similar way by sending enough information in a URL as the request to BCM's Search Launcher. The last step before deploying the services is writing the definition of the service interface description and the definition of the service implementation description. Many profit and non-profit tools are now available to help generate the definitions. JAVA2WSDL tool included in IBM's Web Services Toolkit (WSTK) may be used for preparing the definition.

Then, the service interface and service implementation are preferably published to service registry 14 from where the related services can be easily searched. Accordingly, integration of microarray data analysis applications is achieved for drug target identification. This embodiment makes it possible for heterogeneous applications to be integrated and implement the same function interface for instant browsing capability of different web services.

FIG. 5 is a block diagram that illustrates a computer system 100 which can be used as user computer 20, biology registry 22 and analysis service providers 24, 26 and 28 shown in FIGS. 3 and 4. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or flat panel or touch panel display for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A touch panel (screen) display may also be used as an input device.

The embodiment is related to the use of user computer 20, biology registry 22 and analysis service providers 22, 24 and 26 for analyzing microarray experiment data. According to one embodiment of the invention, functions performed by each of user computer 20, biology registry 22 and analysis service providers 22, 24 and 26 may be provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also preferably includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120, and communication interface 118. In the Internet example, a server 130 might transmit a requested code for an application program through Internet 128, ISP 126, local network 122 and communication interface 118. In accordance with the invention, one such downloaded application provides for an on-line survey having the auto-scrolling as described herein. The received code may be executed by processor 104 as it is received, and/or stored in storage device 110, or other non-volatile storage for later execution. In this manner, computer system 100 may obtain application code in the form of a carrier wave.

Although illustrated as separate blocks in FIG. 3 for discussion of the principles of the invention, those of skill in the art will appreciate that user computer 20, biology registry 22, and microarray experimental data memory may all be contained in a single computer system or each contained in independently computers in communication with each other. Those of skill in the art will also appreciate that service providers 24, 26 and 28 may also be located in different locations or the same location as each other, and may be embodied by a different computer systems or by a single computer system. Those of skill in the art will further appreciate that while the present invention allows communication with service providers utilizing different computer formats through abstraction provided by the system architecture of the present invention, the service providers may utilize the same computer formats.

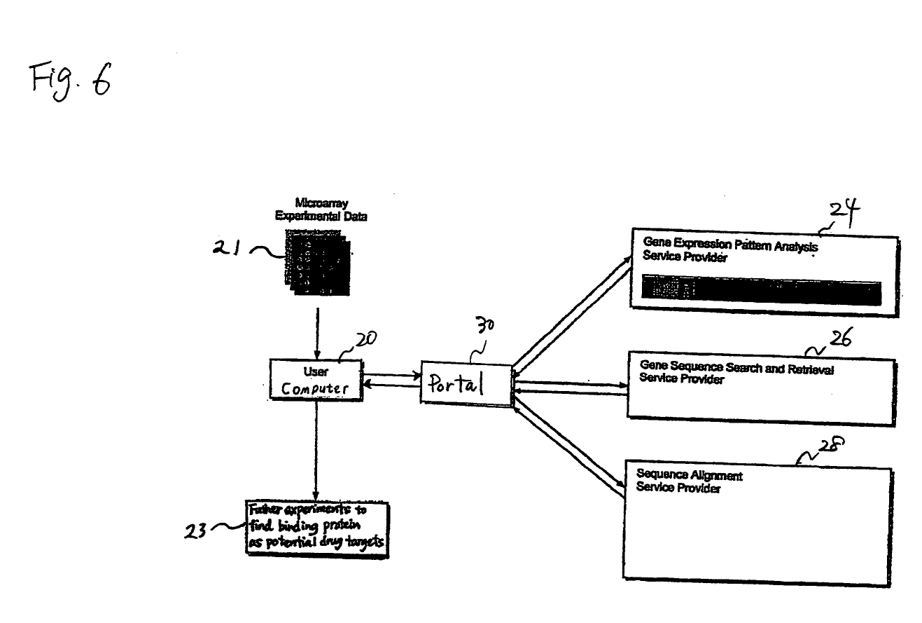

FIG. 6 is a block diagram showing a system for analyzing a microarray experiment of another embodiment. In the system shown in FIG. 6, a portal 30 is built to consume the services described above. In FIG. 6, the services performed by the service analysis providers can be invoked independently as network accessible stand-alone applications, and may be invoked to perform tasks in order shown in FIG. 4. For example,

In FIG. 6, analysis service providers 24, 26 and 28 may be configured for analyzing the microarray experiment data. Portal 30 may store service provider information including at least what type of analysis each service provider can perform so that user computer 20 can conduct a search to find appropriate service providers. For example, portal 30 can serve as a gateway to service providers 24, 26, 28 and other service provider. Portal 30 may also provide a service to guide a user (user computer 20) to service providers which provide necessary analyses by, for example, giving user computer 20 links to service providers. Moreover, portal 30 may have another service to serve as an intermediary to locate a service provider which provide a user-requesting analysis and access to that service provider to support user computer 20 for completion of the analysis of microarray experimental data.

For example, if portal 30 can support user to complete analyses of microarray experimental data based on a user's preference, user computer 20 may provide to portal 30 analysis procedure information to perform necessary analyses of the microarray experiment data, and communicating with portal 30 to perform the necessary analyses of the microarray experiment data with service providers to be selected. The analysis procedure information defined by a user includes at least identifying a gene expression pattern from the microarray experiment data, retrieving sequences of genes with similar expression patterns to that identified by the first analysis, and clustering the sequences retrieved by the second analysis to find similar fragments. Portal 30 preferably selects service providers which perform the steps on the service provider information and helps the user computer 30 communicate with analysis service providers 24, 26 and 28. For example, two or more service providers providing the same analysis are located, portal 30 may request user computer 20 (user) to select one of them, or portal 30 itself may select one of them based on a predetermined selection standard. The embodiment of FIG. 6 preferably performs the process illustrated in FIG. 4.

The following processes are performed through portal 30 based on the analysis procedure information.

For example, the Genes@Work service may act as service provider 24 first processes two input microarray data files and generates a result file with all identified gene expression patterns. User computer 30 can choose which pattern is of user's interest by giving a pattern number to the result. Then, user computer 30 may automatically retrieve a gene accession number for each gene in the pattern and call the NCBI service acting as service provider 26 to obtain the corresponding gene sequence. After all sequences have been retrieved and concatenated into a text string, user computer 30 may invoke the BCM service acting as service provider 28 with this string as an input. A returned result preferably consists of a clustered sequence with the similar fragments marked.

The present invention provides more flexibility for researchers to use functionality provided by distinct service provider applications. With portal 30 that can link with loosely coupled web services, service providers 24, 26 and 28, a researcher can compose a comprehensive analysis procedure by selecting the web services for the corresponding analysis steps. The data integration through web services streamlines the analysis process and allows the researcher to obtain valuable analyses on their data without acquiring the tools for the analysis themselves.

Having described embodiments, it is noted that modifications and variations can be made by persons skilled in the art in light of the above teachings. It is therefore to be understood that changes may be made in the particular embodiments disclosed that are within the scope and sprit of the disclosure as defined by the appended claims and equivalents.

What is claimed is:

1. An analyzing system for analyzing microarray experiment data showing the arrangement of a gene to identify targets in drug discovery, comprising:
a plurality of service providers each configured to analyze the microarray experiment data in a predetermined manner;
a registry configured to store analysis information including at least which type of analysis each service provider can perform; and
a service requester configured to select at least one of the service providers which performs a desired analysis on the microarray experiment data based on the analysis information in the registry, requesting the selected service provider to analyze the microarray experiment data, and receiving an analysis result from the selected service provider.

2. The analyzing system according to claim 1, wherein
the service providers, registry and service requester are connected to each other through a network.

3. The analyzing system according to claim 1, wherein
the service providers include at least:
a first service provider configured to perform a first analysis on the microarray data and provide an identification of one or more genes which have a common expression pattern to the service requestor;
a second service provider configured to perform a second analysis on the one or more genes identified by the first service provider and provide corresponding gene sequences to the service requester; and
a third service provider configured to perform a third analysis on the gene sequences and provide an alignment of fragments of the gene sequences to the service requestor.

4. The analyzing system according to claim 3 wherein,
the analysis information stored in the registry includes information regarding the first, second and third analyses, and
the service requestor locates the analysis information regarding the first, second and third analyses, and selects the first, second and third service providers to analyze the microarray experiment data.

5. The analyzing system according to claim 3, wherein
the analysis information further includes information regarding request formats to be accepted by the respective first to third service providers, and
the service requestor requests the first to third service providers based on the request formats included in the analysis information.

6. The analyzing system according to claim 1, wherein
the service providers, registry and service requestor are configured for communicating with each other based on tag-based markup language.

7. The analyzing system according to claim 5, wherein
the tag-based markup language is extensible markup language (XML).

8. An analyzing system for analyzing microarray experiment data showing the arrangement of a gene to identify targets in drug discovery comprising:
a plurality of service providers each configured to analyze the microarray experiment data in a predetermined manner;
a portal configured to store service provider information including at least which type of analysis each service provider can perform; and
a service requester configured to provide portal analysis procedure information to perform necessary analyses of the microarray experiment data, and communicating with the portal to perform the necessary analyses of the microarray experiment data with service providers to be selected, wherein
the portal is further configured for selecting service providers based on the service provider information.

9. The analyzing system according to claim 8, wherein
the portal analysis procedure information includes at least a first analysis for identifying a gene expression pattern from the microarray experiment data; a second analysis for retrieving sequences of genes with similar expression patterns to that identified by the first analysis; and a third analysis for clustering the sequences retrieved by the second analysis to locate similar fragments, and
the portal is configured to select service providers which perform the respective first second and third analyses based on the service provider information.

10. The analyzing system according to claim 8, wherein
the service providers include at least:
a first service provider configured to perform a first analysis on the microarray data and provide an identification of one or more genes which have a common expression pattern to the service requestor;
a second service provider configured to perform a second analysis on the one or more genes identified by the first service provider and provide corresponding gene sequences to the service requester; and
a third service provider configured to perform a third analysis on the gene sequences and provide an alignment of fragments of the gene sequences to the service requester.

11. A method for analyzing microarray experiment data indicative of characteristics of a gene to identify targets in drug discovery, comprising the steps of:
storing analysis information including at least which type of analyses a plurality of service providers can perform, the service providers each configured for analyzing the microarray experiment data in a predetermined manner;
selecting at least one of the service providers which performs a desired analysis on the microarray experiment data based on the analysis information;
providing a first remotely located service provider the microarray data and receiving an identification of one or more genes which have a common expression pattern;
providing a second remotely located service provider the one or more genes identified by the first service provider and receiving corresponding gene sequences; and
providing a third remotely located service provider the gene sequences and receive an alignment of fragments of the gene sequences.

12. The method according to claim 11, wherein
the steps of providing a first service provider the microarray data and receiving an identification of one or more genes which have a common expression pattern; providing a first service provider the one or more genes identified by the first service provider and receiving corresponding gene sequences; and providing a third service provider the gene sequences and receive an alignment of fragments of the gene sequences are performed through a computer network.

13. The method according to claim 12, wherein
the analysis information further includes information regarding request formats to be accepted by the respective first to third service providers, and
the step of requesting includes preparing requests to the first to third service providers based on the request formats included in the analysis information.

14. The method according to claim 12, wherein
the steps of selecting, requesting and receiving are performed based on tag-based markup language.

15. The method according to claim 14, wherein
the tag-based markup language is extensible markup language (XML).

16. The method according to claim 12, wherein the steps of providing a first service provider the microarray data and receiving an identification of one or more genes which have a common expression pattern; providing a first service provider the one or more genes identified by the first service provider and receiving corresponding gene sequences; and providing a third service provider the gene sequences and receive an alignment of fragments of the gene sequences are further performed through a portal which interfaces with the Internet.

17. The method according to claim 16, wherein the portal selects at least one of the first service provider, second service provider or third service provider from among a plurality of service providers.

18. A computer readable medium, bearing instructions for a computer to perform the steps of:
storing analysis information including at least which type of analyses a plurality of service providers can perform, the service providers each configured for analyzing the microarray experiment data in a predetermined manner;
selecting at least one of the service providers which performs a desired analysis on the microarray experiment data based on the analysis information;
providing a first service provider the microarray data and receiving an identification of one or more genes which have a common expression pattern;
providing a first service provider the one or more genes identified by the first service provider and receiving corresponding gene sequences; and
providing a third service provider the gene sequences and receive an alignment of fragments of the gene sequences.

19. The computer readable medium according to claim 18, wherein
the steps of providing a first service provider the microarray data and receiving an identification of one or more genes which have a common expression pattern; providing a first service provider the one or more genes identified by the first service provider and receiving corresponding gene sequences; and providing a third service provider the gene sequences and receive an alignment of fragments of the gene sequences are performed through a network.

20. The computer readable medium according to claim 19, wherein
the analysis information further includes information regarding request formats to be accepted by the respective first to third service providers, and
the step of requesting includes preparing requests to the first to third service providers based on the request formats included in the analysis information.

21. The computer readable medium according to claim 19, wherein
the steps of selecting, requesting and receiving are performed based on tag-based markup language.

22. The computer readable medium according to claim 21, wherein
the tag-based markup language is extensible markup language (XML).

23. The computer readable medium according to claim 19, wherein the steps of providing a first service provider the microarray data and receiving an identification of one or more genes which have a common expression pattern; providing a first service provider the one or more genes identified by the first service provider and receiving corresponding gene sequences; and providing a third service provider the gene sequences and receive an alignment of fragments of the gene sequences are further performed through a portal which interfaces with the Internet.

24. The computer readable medium according to claim 23, wherein the portal selects at least one of the first service provider, second service provider or third service provider from among a plurality of service providers.
